(19) United States
(12) Patent Application Publication
(10) Pub. No.: US 2026/0319134 A1
(43) Pub. Date: Oct. 15, 2026

(54) METASURFACE LENS AND DESIGN METHOD OF THE SAME FOR SHAPING GAUSSIAN LIGHT INTO PARALLEL UNIFORM LIGHT

(71) Applicants: HUAZHONG UNIVERSITY OF SCIENCE AND TECHNOLOGY, Hubei (CN); OPTICS VALLEY LABORATORY, Hubei (CN)

(72) Inventors: Fei YI, Hubei (CN); Yan CHEN, Hubei (CN); Sitan LIU, Hubei (CN); Linhan LI, Hubei (CN); Yongchao LIN, Hubei (CN)

(73) Assignees: HUAZHONG UNIVERSITY OF SCIENCE AND TECHNOLOGY, Hubei (CN); OPTICS VALLEY LABORATORY, Hubei (CN)

(21) Appl. No.: 19/160,457

(22) PCT Filed: Mar. 28, 2024
(86) PCT No.: PCT/CN2024/084452

§ 371 Date: Jun. 15, 2026

(30) Foreign Application Priority Data
Dec. 15, 2023 (CN) 202311731063.X

(51) Int. Cl. G02B 1/00; G02B 1/11; G02B 27/00; G02B 27/09

(52) U.S. Cl. CPC G02B 1/002; G02B 1/11; G02B 27/0012; G02B 27/0927; G02B 27/0955

(57) ABSTRACT

The invention discloses a metasurface lens and design method for shaping Gaussian light into parallel uniform light, belonging to the field of laser technology. The metasurface lens includes a dielectric substrate layer and a metasurface microstructure. The metasurface microstructure includes a first metasurface and a second metasurface distributed on both sides of the dielectric substrate layer, and which are both formed by a plurality of columnar microstructure units arranged periodically. Based on an irradiance distribution of Gaussian light and target parallel uniform light, a distribution of columnar microstructure units of the metasurface lens is optimized and designed, so that an outgoing light beam is parallel to an optical axis and uniformly distributed within a target range. Laser shaping is implemented and a target light beam is obtained, while an optical system has a simple structure and wide range of use and is suitable for laser shaping of various laser devices.

### TECHNICAL FIELD

The invention belongs to the field of laser technology, and more specifically, relates to a metasurface lens and design method for shaping Gaussian light into parallel uniform light.

### DESCRIPTION OF RELATED ART

Lasers are generally Gaussian light beams, i.e., the light beam intensity follows a Gaussian distribution in space, and such a light beam has the characteristic of very high intensity in the center and gradually decreasing outward along the Gaussian profile. In practical applications, the non-uniformity of energy distribution may cause excessively high local temperature, so that the interaction between lasers and matters is affected. Further, the peripheral energy is excessively low, so the utilization rate is lowered, and the application scenarios of lasers are thus limited. Therefore, in many laser application fields, it is necessary to shape Gaussian light beams to obtain flat-top light beams with good uniformity. A flat-top light beam refers to a laser light beam with uniform energy density within the cross-section in the light beam transmission direction. Due to its characteristic of uniform energy distribution, it has important applications in laser welding, laser drilling, laser ablation, laser medical treatment, laser display, and other fields. Uniform spots may perform uniform laser processing on the working surface, and materials are thus prevented from being damaged. In addition, the sharp boundary of a spot may clearly distinguish the processed region from the unprocessed region. However, when flat-top light beams propagate in the free space, the intensity shape may change, so it is not conducive to long-distance propagation. Parallel uniform light not only satisfies the characteristics of flat-top light, but is also a group of parallel light rays with insignificant attenuation within a certain distance.

At present, the methods for achieving laser shaping and homogenization mainly include the aspherical lens method and the diffractive optical element method, etc. The light beam shaping system using the aspherical lens method is designed according to the geometric optics principles, and the system includes one or more aspherical lenses. Its disadvantages lie in large volume, complex structure, expensive costs, etc. The light beam shaping system using the diffractive optical element method is designed according to the diffractive optics principles, and the system usually includes a diffractive optical element and a focusing lens closely adjacent to the diffractive optical element. Disadvantages such as relatively complex manufacturing process of diffractive optical elements, difficulty in integration with refractive lenses, difficulty in reducing volume, and high costs are found. Meanwhile, due to the immaturity of multiple photolithography processes, the phase distribution needs to be quantized in design, making it difficult to achieve continuous phase variation control for more precise wavefront modulation.

Metasurface lenses are lightweight and compact, with flat surfaces having nanostructures. Fine modulation on the incident light may be performed by means of artificially designed nanostructures. Currently, metasurface lenses are also used for laser collimation or spot shaping. For instance, Chinese patent CN112859206B discloses a preparation method of an all-dielectric metalens for shaping Gaussian light into flat-top light. However, only the incident light is shaped into the flat-top light, i.e., uniformly distributed on the image plane, and parallel emission of the outgoing light is not achieved. This results in the all-dielectric metalens described in this patent having limitations on working distance and certain requirements for tolerance of spacing from the image plane, which is not conducive to practical assembly applications.

### SUMMARY

In view of the defects of the related art, the invention aims to provide a metasurface lens and design method for shaping Gaussian light into parallel uniform light, so as to simplify existing optical systems, reduce limitations on working distance, and lower requirements for assembly precision.

To achieve the above, in the first aspect, the invention provides a metasurface lens for shaping Gaussian light beam into parallel uniform light, and the metasurface lens includes: a dielectric substrate layer and a metasurface structure.

The metasurface lens is used to shape an incident Gaussian light beam to form an outgoing light beam that is parallel to an optical axis and uniformly distributed within a target range.

The metasurface microstructure is formed by arranging a plurality of columnar microstructure units into a tetragonal lattice or hexagonal lattice periodic array. A distribution of the columnar microstructure units matches the incident light beam, so that the outgoing light beam is parallel to the optical axis and uniformly distributed within the target range.

Optionally, heights of the columnar microstructure units are all the same and are on a wavelength order of an incident laser emitted by the laser device, and diameters of the columnar microstructure units are on a sub-wavelength order.

$${φ}_{1} = [ {{A}_{1} ( \frac{ρ}{R} )}^{2} + {{A}_{2} ( \frac{ρ}{R} )}^{4} + … + {{A}_{n - 1} ( \frac{ρ}{R} )}^{2 n - 2} + {{A}_{n} ( \frac{ρ}{R} )}^{2 n} ] ( 2 π rad ) = {\sum }_{i = 1}^{n} {{A}_{i} ( \frac{ρ}{R} )}^{2 i} ( 2 π rad ) ( i = 1 , 2 , 3 , … n ) , and \\ {φ}_{2} = [ {{B}_{1} ( \frac{ρ}{R} )}^{2} + {{B}_{2} ( \frac{ρ}{R} )}^{4} + … + {{B}_{n - 1} ( \frac{ρ}{R} )}^{2 n - 2} + {{B}_{n} ( \frac{ρ}{R} )}^{2 n} ] ( 2 π rad ) = {\sum }_{i = 1}^{n} {{B}_{i} ( \frac{ρ}{R} )}^{2 i} ( 2 π rad ) ( i = 1 , 2 , 3 , … n ) ,$$

where φ₁ and φ₂ are phase distributions of a first metasurface and a second metasurface respectively, ρ represents radial coordinates of a metasurface, R is a normalized radius, n is a maximum number of terms in the phase distribution, and Aᵢ and Bᵢ(i=1, 2, 3, . . . n) are both polynomial coefficients.

Optionally, a diameter, period, height, and arrangement of the columnar microstructure units are determined according to the corresponding phase distribution.

Optionally, both front and back surfaces of the metasurface lens are coated with anti-reflection coating layers.

Optionally, a material refractive index of the columnar microstructure units is greater than or equal to a material refractive index of the dielectric substrate layer.

Optionally, the metasurface lens is a double-sided metasurface lens.

In the second aspect, the invention further provides a design method of the metasurface lens for shaping Gaussian light into parallel uniform light as described in any one of the first aspect, and the following steps are included.

In S1, according to a working wavelength of a laser emitter and a beam waist diameter of an emitted laser, as well as a shape and size of a target spot, the phase distribution of the metasurface lens is calculated.

In S2, according to the current phase distribution of the metasurface lens, the parameters of the outgoing light beam formed after the laser is shaped by the metasurface lens is calculated, where the parameters of the outgoing light beam include: the shape, size, and uniformity of the spot of the outgoing light beam on the image plane.

In S3, if the shape, size, and uniformity of the spot of the outgoing light beam on the image plane satisfy the design needs, S5 is executed; otherwise, according to the working wavelength of the laser emitter and the beam waist diameter of the emitted laser, the phase distribution parameters of the metasurface lens are optimized and updated through a damped least squares method and a self-defined optimization algorithm.

In S4, the updated phase distribution is substituted into and S2 to S3 are repeatedly executed until the shape, size, and uniformity of the spot of the outgoing light beam on the image plane obtained in S2 satisfy the design needs.

In S5, according to the current phase distribution of the metasurface lens, the size and arrangement of the plurality of columnar microstructure units in the metasurface lens are designed.

In S6, according to the data in S5, the metasurface lens is fabricated to construct a laser shaping optical system.

Optionally, S5 includes the following.

Coefficient fitting is performed on the target phase distribution of the metasurface lens, so that discrete points of the fitted phase distribution correspond one-to-one with the columnar microstructure units of the metasurface lens.

A correspondence relationship between the size and phase distribution of the columnar microstructure units in the metasurface lens and transmittance is simulated and obtained.

According to the phase distribution after the coefficient fitting, the correspondence relationship is queried to obtain the size and arrangement of the plurality of columnar microstructure units.

Optionally, the simulating and obtaining the correspondence relationship of the size and phase distribution of the columnar microstructure units in the metasurface lens includes the following.

According to a finite-difference time-domain algorithm and a rigorous coupled-wave analysis method, size parameters of the columnar microstructure units of the metasurface lens are simulated to determine the correspondence relationship between a height, period, diameter, and phase distribution of the columnar microstructure units and the transmittance.

Through the above technical solutions conceived by the invention, compared to the related art, the following beneficial effects are achieved:
1. The invention provides a metasurface lens for shaping Gaussian light into parallel uniform light. The metasurface lens, by virtue of its fine control capability over incident light, achieves laser shaping and enables the target light beam to emit in a parallel and uniform manner. No strict requirements are needed for the working distance, and tolerance required for the distance from the image plane is low, so limitations on the working distance is reduced. The optical system structure is thus simplified, a wide range of applications is provided, and it is suitable for laser shaping of various types of laser devices.
2. The invention provides a metasurface lens for shaping Gaussian light into parallel uniform light. By adopting the optimization function algorithm and the damped least squares method with personalized settings in simulation software to optimize the normalized radius R and the phase distribution polynomial coefficients of the metasurface lens, the distribution pattern of the square lattice or hexagonal lattice periodic array of the metasurface microstructure is determined, and the phase and amplitude distribution of the light beam is thus precisely adjusted. The light beam shaping and modulation functions are thus implemented, parallel emission is implemented, and the uniformity of the spot of the emitted light beam on the image plane is ensured.

### BRIEF DESCRIPTION OF THE DRAWINGS

FIG. 1 is a schematic view of a structure of a metasurface lens for shaping Gaussian light into parallel uniform light provided by an embodiment of the invention.

FIG. 2 is a schematic view of one microstructure unit periodically arranged in the metasurface lens in an embodiment of the invention.

FIG. 3 is a schematic view of a structure of a laser shaping system in an embodiment of the invention.

FIG. 4 is a schematic graph of normalized sudden phase change generated by columnar microstructure units of the metasurface lens of a first optical system under different diameters and microstructure transmittance in Embodiment One of the invention.

FIG. 5(a) is a two-dimensional irradiance distribution image of circular uniform parallel light emitted after laser shaping by the first optical system provided in Embodiment One of the invention.

FIG. 5(b) is a one-dimensional irradiance distribution graph of the circular uniform parallel light emitted after laser shaping by the first optical system provided in Embodiment One of the invention.

FIG. 6 is a schematic graph of normalized sudden phase change generated by the columnar microstructure units of the metasurface lens of a second optical system under different diameters and the microstructure transmittance in Embodiment One of the invention.

FIG. 7(a) is a two-dimensional irradiance distribution image of the circular uniform parallel light emitted after laser shaping by the second optical system provided in Embodiment One of the invention.

FIG. 7(b) is a one-dimensional irradiance distribution graph of the circular uniform parallel light emitted after laser shaping by the second optical system provided in Embodiment One of the invention.

FIG. 8(a) is a two-dimensional irradiance distribution image of elliptical uniform parallel light emitted after laser shaping by a third optical system provided in Embodiment One of the invention.

FIG. 8(b) is a one-dimensional (major axis direction) irradiance distribution image of the elliptical uniform parallel light emitted after laser shaping by the third optical system provided in Embodiment One of the invention.

FIG. 8(c) is a one-dimensional (minor axis direction) irradiance distribution image of the elliptical uniform parallel light emitted after laser shaping by the third optical system provided in Embodiment One of the invention.

In the accompanying drawings and tables, the same reference numerals are used to represent identical or similar elements or structures, where 1: laser emitter, 2: metasurface lens, 201: first metasurface, 202: second metasurface, 203: dielectric substrate layer, and 3: image plane.

### DESCRIPTION OF THE EMBODIMENTS

In order to make the objectives, technical solutions, and advantages of the invention clearer and more comprehensible, the invention is further described in detail with reference to the drawings and embodiments. It should be understood that the specific embodiments described herein serve to explain the invention merely and are not used to limit the invention. In addition, the technical features involved in the various embodiments of the invention described below can be combined with each other as long as the technical features do not conflict with each other.

A metasurface lens is a special optical element that utilizes microstructure arrays on the surface to achieve optical functions and thus exhibits excellent optical control capabilities. The periodic microstructures artificially designed and arranged on its surface may precisely adjust the phase and amplitude distribution of light beams, so that functions such as light beam focusing, beam splitting, deflection, and modulation are achieved, and characteristics of compactness, flexibility, and high efficiency are provided.

The following explains the content involved in the above embodiment in combination with a preferred embodiment.

### Embodiment One

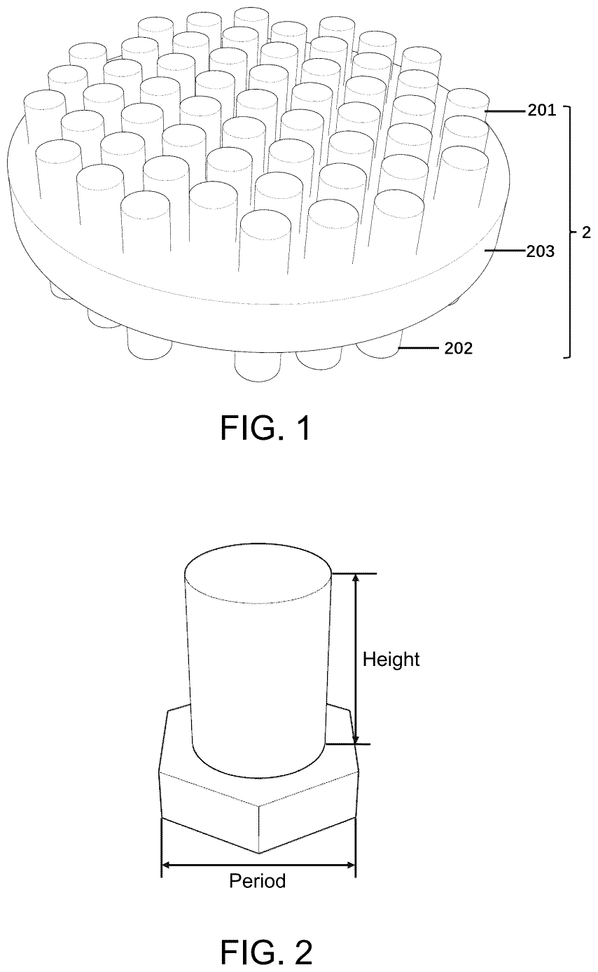

The invention provides a metasurface lens for shaping a Gaussian light beam into parallel uniform light. As shown in FIG. 1, the metasurface lens includes: a dielectric substrate layer and a metasurface microstructure.

The metasurface lens is used to shape an incident Gaussian light beam to form an outgoing light beam that is parallel to an optical axis and uniformly distributed within a target range.

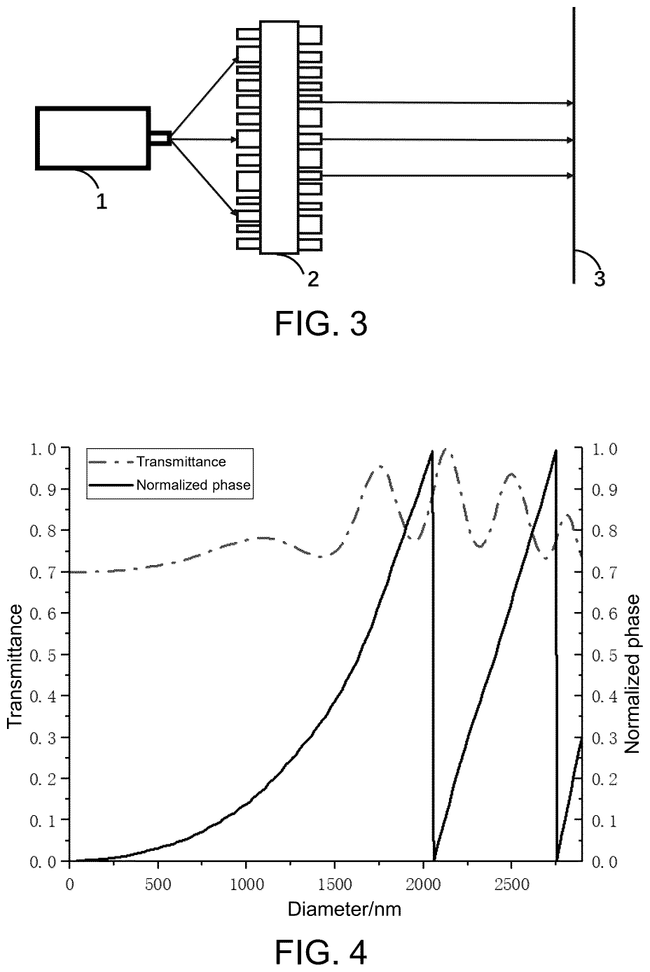

FIG. 2 is a schematic view of one microstructure unit periodically arranged in the metasurface lens in an embodiment of the invention. The metasurface microstructure is formed by arranging a plurality of columnar microstructure units into a tetragonal lattice or hexagonal lattice periodic array. A distribution of the columnar microstructure units matches the incident light beam, so that the outgoing light beam is parallel to the optical axis and uniformly distributed within the target range. FIG. 3 is a schematic view of a structure of a laser shaping system in an embodiment of the invention. The laser shaping system includes: a laser emitter, a metasurface lens, and an image plane.

The calculation standard for spot uniformity is as follows. For a spot with center-distributed symmetry, within the range of [−R, R], illuminance uniformity within the spot is

$$u = \frac{\overline{E}}{{E}_{o}} ,$$

where Ē is an average value of illuminance in the spot, E₀ is peak illuminance, and

$$\overline{E} = {\int }_{- R}^{R} E d x / 2 R and u = \frac{\overline{E} = {\int }_{- R}^{R} E d x}{2 R {E}_{o}} 0 .$$

When u increases, it indicates that an area of the illuminance within the spot is closer to an area of the peak illuminance within the spot, and improved uniformity of illuminance is provided. Obviously u<1. Therefore, the value of u may be used to measure the quality of illuminance uniformity within the spot.

The embodiments of the invention provide a metasurface lens for shaping a Gaussian light beam into parallel uniform light. A metasurface component is used to control incident light, so that shaping of the incident light is implemented, and that the outgoing light beam is ensured to be parallel to the optical axis and is uniformly distributed within the target range.

Both front and back surfaces of the metasurface lens are coated with anti-reflection coating layers for a target wavelength band. A metasurface of the metasurface lens is formed by arranging columnar microstructure units according to the tetragonal lattice or hexagonal lattice periodic array, which is a planar structure. Heights of the columnar microstructure units are all the same and are on a wavelength order of an incident laser emitted by the laser device, and diameters of the columnar microstructure units are on a sub-wavelength order. A material refractive index of the columnar microstructure units is greater than or equal to a material refractive index of the dielectric substrate layer. The specific combination of materials is related to a target wavelength, for example, the material of the columnar structure units is silicon or titanium dioxide, and the material of the dielectric substrate layer is silicon or silicon dioxide.

An irradiance distribution of the incident Gaussian light beam and an irradiance distribution of the spot on the image plane of the outgoing light beam are discretized and matched according to a working wavelength of the laser emitter and a beam waist diameter of the emitted laser, as well as a shape and size of the target spot. The outgoing light beam is discretized to make it emit parallel to the optical axis. Further, an optimization function algorithm and a damped least squares method with personalized settings in simulation software are used to optimize a normalized radius R and phase distribution polynomial coefficients of the metasurface lens, and that arrangement and a distribution pattern of the metasurface microstructure periodic array are determined.

A phase distribution φ of the columnar microstructure unit periodic array satisfies the following expression:

$${φ}_{1} = [ {{A}_{1} ( \frac{ρ}{R} )}^{2} + {{A}_{2} ( \frac{ρ}{R} )}^{4} + … + {{A}_{n - 1} ( \frac{ρ}{R} )}^{2 n - 2} + {{A}_{n} ( \frac{ρ}{R} )}^{2 n} ] ( 2 π rad ) = {\sum }_{i = 1}^{n} {{A}_{i} ( \frac{ρ}{R} )}^{2 i} ( 2 π rad ) ( i = 1 , 2 , 3 , … n ) , and \\ {φ}_{2} = [ {{B}_{1} ( \frac{ρ}{R} )}^{2} + {{B}_{2} ( \frac{ρ}{R} )}^{4} + … + {{B}_{n - 1} ( \frac{ρ}{R} )}^{2 n - 2} + {{B}_{n} ( \frac{ρ}{R} )}^{2 n} ] ( 2 π rad ) = {\sum }_{i = 1}^{n} {{B}_{i} ( \frac{ρ}{R} )}^{2 i} ( 2 π rad ) ( i = 1 , 2 , 3 , … n ) ,$$

where φ₁ and φ₂ are phase distributions of a first metasurface and a second metasurface respectively, ρ represents radial coordinates of the metasurface, R is the normalized radius, and n is the maximum number of terms in the phase distribution.

Aᵢ(i=1, 2, 3, . . . n) are the quadratic term, quartic term, sixth term . . . , and 2n^{th} term coefficients of columnar microstructure unit phase distribution parameters of the first metasurface, and Bᵢ(i=1, 2, 3, . . . n) are the quadratic term, quartic term, sixth term . . . , and 2n^{th} term coefficients of columnar microstructure unit phase distribution parameters of the second metasurface. The phase distribution of the metasurface microstructure adopts the form of high-order even-degree polynomials, so an optimization solution space is expanded, and the number of optimization parameters to sufficiently achieve the design objectives increases.

Optionally, the diameter, period, height, and arrangement of the columnar microstructure units are determined according to the corresponding phase distribution.

The size and phase distribution of the columnar microstructure units have a corresponding relationship. After the phase distribution is determined, the diameter of the columnar microstructure units may be obtained according to the corresponding relationship.

Using a finite-difference time-domain algorithm and a rigorous coupled-wave analysis method, the size parameters of the columnar microstructure units of the metasurface are simulated to determine the corresponding relationship between microstructure height, period, and diameter and the generation of sudden phase change. Based on the corresponding relationship between the microstructure diameter and the generation of sudden phase change, combined with the phase distribution of the metasurface hexagonal lattice periodic array, the diameter of the microstructure at the corresponding position of the metasurface lens is determined. The period, height, and diameter of the columnar microstructure units all affect the phase delay, and even the transmittance of the metasurface microstructure. In the simulation process, according to the target wavelength, an appropriate period and height range is selected, then through simulation within the selected height and period range, the relationship between the diameter of the columnar microstructure units and the phase delay is calculated. Further, under the condition of ensuring high transmittance, this set of period and height is selected.

In a specific embodiment, an incident laser wavelength is 10.6 micrometers, the beam waist diameter is 3.5 mm, and the microstructure of the metasurface lens is a cylindrical structure with a period P of 3 μm, a height H of 12 μm, and a diameter D ranging from 2 μm to 2.8 μm. According to a phase-dispersion distribution, metasurface microstructures that are near a same dispersion level line and can cover the full 2π phase are identified, which are the required microstructure units. FIG. 4 is a schematic graph of normalized sudden phase change generated by columnar microstructure units of the metasurface lens of a first optical system under different diameters and microstructure transmittance in Embodiment One of the invention. Within this diameter range and fixed height, microstructure units with higher transmittance and consistent dispersion are preferred.

More specifically, the specific parameter values in the optical system provided by the embodiments of the invention are shown in Table 1 and Table 2.

TABLE 1
Table of first metasurface lens parameters

| | R(mm) | A₁ | A₂ | A₃ | A₄ |
|---|---|---|---|---|---|
| Metasurface 201 | 1 | −587.421 | −24.934 | 2.249 | 4.125 |
| | R(mm) | A₅ | A₆ | A₇ | A₈ |
| Metasurface 201 | 1 | −1.734 | 0.364 | −0.046 | 3.425E−03 |
| | R(mm) | A₉ | A₁₀ | A₁₁ | A₁₂ |
| Metasurface 201 | 1 | −9.735E−05 | −5.512E−06 | −5.596E−07 | −1.433E−08 |
| | R(mm) | A₁ | A₂ | A₃ | A₄ |
| Metasurface 202 | 1 | 367.686 | 256.001 | 10.735 | −73.669 |
| | R(mm) | A₅ | A₆ | A₇ | A₈ |
| Metasurface 202 | 1 | 390.125 | −1072.541 | 1610.984 | −888.697 |
| | R(mm) | A₉ | A₁₀ | A₁₁ | A₁₂ |
| Metasurface 202 | 1 | −1056.971 | 2245.537 | −1557.446 | 402.733 |

TABLE 2
Optical structure parameters of first optical system

| | Radius of Curvature | Thickness or | Material or | Aperture |
|---|---|---|---|---|
| Component | (mm) | Spacing (mm) | Model No. | (mm) |
| Laser emitter 1 | — | — | — | — |
| | — | 1 | | — |
| Double-sided | Infinity (metasurface) | 0.725 | Silicon | 5.4 |
| metasurface lens 2 | Infinity (metasurface) | 5 | | 5.4 |
| Image plane 3 | Infinity | — | — | 2 |

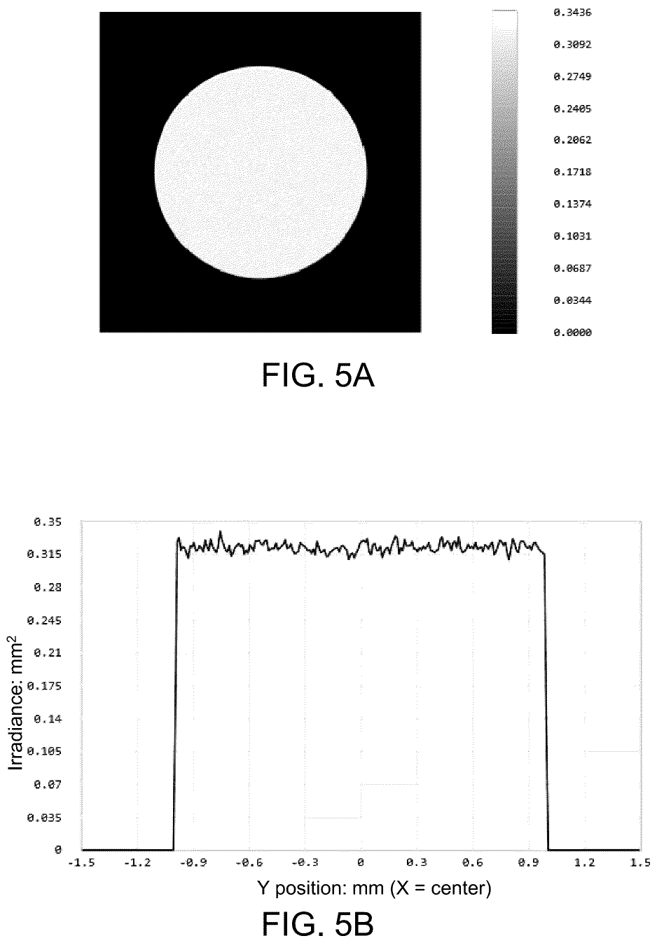

Calculation is performed using the uniformity definition formula, and the shaping effect of the optical system provided in this embodiment for a laser with a wavelength of 10.6 micrometers is shown in Table 3. An angle between the outgoing light beam and the optical axis is less than 3.41×10⁻⁴ rad, parallelism of the light beam is good, the target spot is circular, and radius of the spot is 1 mm. The irradiance distribution of the spot on the image plane is shown in FIG. 5(a), and a radial irradiance distribution of the spot on the image plane is shown in FIG. 5(b).

TABLE 3
Uniformity parameters of first optical system

| | Metasurface to Image Plane Distance/mm | | | |
|---|---|---|---|---|
| | 2.5 | 5 | 7.5 | 10 |
| Uniformity in | 0.964 | 0.9675 | 0.9738 | 0.9609 |
| Radial Direction | | | | |

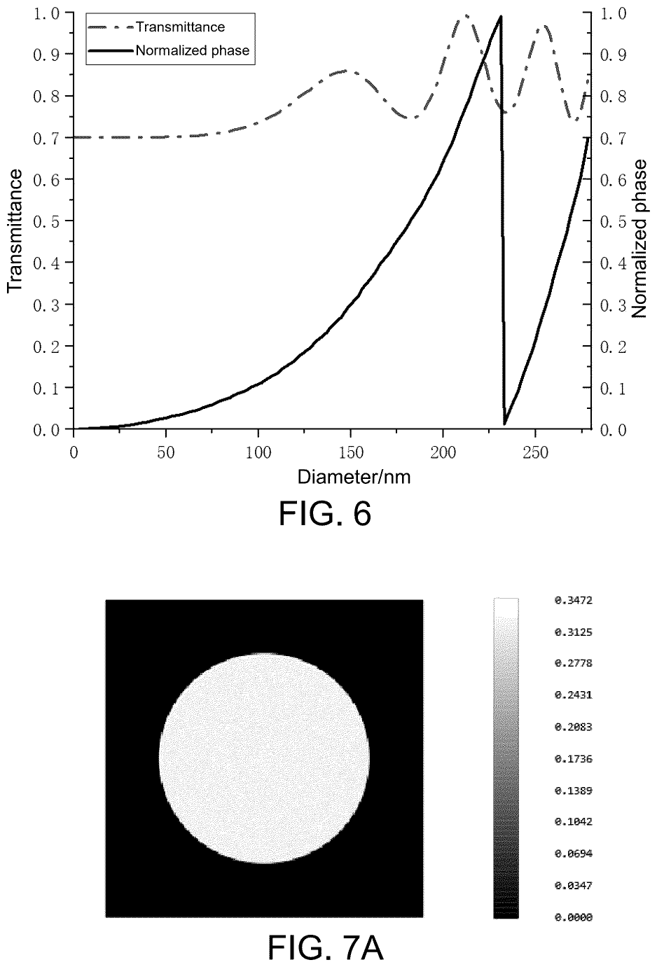

In a specific embodiment, the incident laser wavelength is 1.31 micrometers, the beam waist diameter is 3.5 mm, and the microstructure of the metasurface lens is a cylindrical structure with a period P of 300 nm, a height H of 1300 nm, and a diameter D ranging from 0 to 280 nm. According to the phase-dispersion distribution, metasurface microstructures that are near the same dispersion level line and can cover the full 2π phase are identified, which are the required microstructure units. FIG. 6 is a schematic graph of normalized sudden phase change generated by the columnar microstructure units of the metasurface lens of a second optical system under different diameters and the microstructure transmittance in Embodiment One of the invention. Within this diameter range and fixed height, microstructure units with higher transmittance and consistent dispersion are preferred.

In another embodiment, the specific parameter values are shown in Table 4 and Table 5.

TABLE 4
Table of second metasurface lens parameters

| | R(mm) | A₁ | A₂ | A₃ | A₄ |
|---|---|---|---|---|---|
| Metasurface 201 | 1 | −3816.22 | 61.470 | 53.394 | −11.129 |
| | R(mm) | A₅ | A₆ | A₇ | A₈ |
| Metasurface 201 | 1 | 0.372 | 0.198 | −0.03 | −1.378E−04 |
| | R(mm) | A₉ | A₁₀ | A₁₁ | A₁₂ |
| Metasurface 201 | 1 | 4.697E−04 | −5.485E−05 | −2.784E−06 | −5.536E−08 |
| | R(mm) | A₁ | A₂ | A₃ | A₄ |
| Metasurface 202 | 1 | 1780.513 | 1384.219 | −264.101 | −1256.030 |
| | R(mm) | A₅ | A₆ | A₇ | A₈ |
| Metasurface 202 | 1 | 4382.366 | −7599.781 | −650.067 | 3.295E+04 |
| | R(mm) | A₉ | A₁₀ | A₁₁ | A₁₂ |
| Metasurface 202 | 1 | −7.177E+04 | 7.573E+04 | −4.117E+04 | 9231.938 |

TABLE 5
Optical structure parameters of second optical system

| | Radius of Curvature | Thickness or | Material or | Aperture |
|---|---|---|---|---|
| Component | (mm) | Spacing (mm) | Model No. | (mm) |
| Laser emitter 1 | — | — | — | — |
| | — | 1 | | — |
| Double-sided | Infinity (metasurface) | 0.5 | Silicon | 5.4 |
| metasurface lens 2 | Infinity (metasurface) | 5 | dioxide | 5.4 |
| Image plane 3 | Infinity | — | — | 2 |

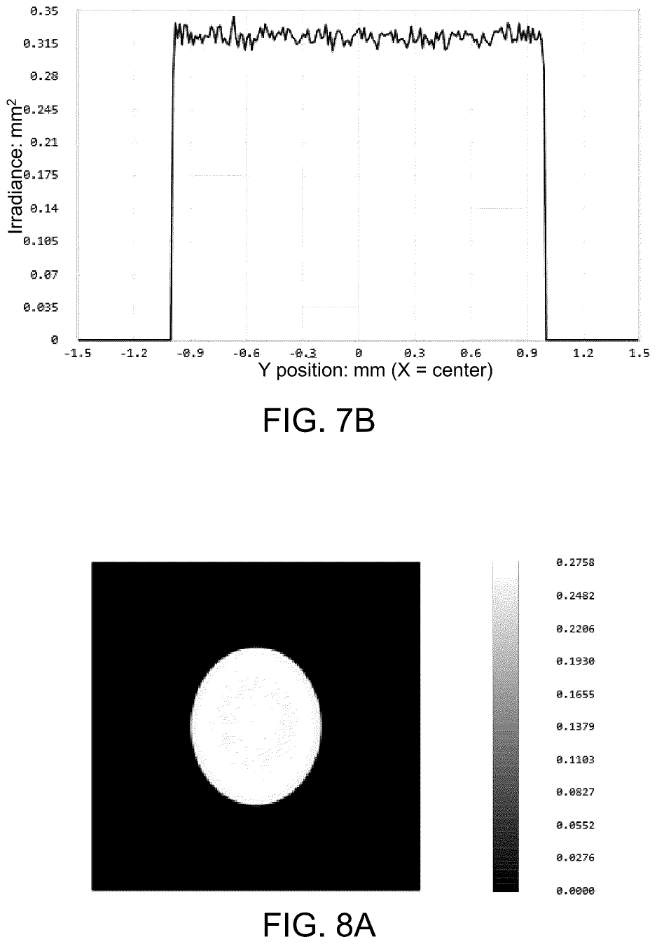

Calculation is performed using the uniformity definition formula, and the shaping effect of the optical system provided in this embodiment for a laser with a wavelength of 1.31 micrometers is shown in Table 6. The angle between the outgoing light beam and the optical axis is less than 3.51× 10⁻⁴ rad, parallelism of the light beam is good, the target spot is circular, and radius of the spot is 1 mm. The irradiance distribution of the spot on the image plane is shown in FIG. 7(a), and the radial irradiance distribution of the spot on the image plane is shown in FIG. 7(b).

TABLE 6
Uniformity parameters of second optical system

| | Metasurface to Image Plane Distance/mm | | | |
|---|---|---|---|---|
| | 2.5 | 5 | 7.5 | 10 |
| Uniformity in | 0.9523 | 0.9388 | 0.9244 | 0.9477 |
| Radial Direction | | | | |

In the above embodiments, double-sided metasurface lenses for different working wavebands and different materials are analyzed, proving that this optical system structure is suitable for shaping various laser devices with different working wavebands. Meanwhile, when changing the distance between the double-sided metalens and the image plane, the calculated uniformity does not change significantly.

In another embodiment, the incident laser wavelength is 10.6 micrometers, the beam waist diameter is 3.5 mm, the microstructure of the metasurface lens is a cylindrical structure with a period P of 3 μm, a height H of 12 μm, and a diameter D ranging from 2 μm to 2.8 μm, and the columnar lens is positioned 5 mm away from the metasurface lens along the optical axis. According to the phase-dispersion distribution, metasurface microstructures that are near the same dispersion level line and can cover the full 2π phase are identified, which are the required microstructure units. Within this diameter range and fixed height, microstructure units with higher transmittance and consistent dispersion are preferred.

Specific parameter values are shown in Table 7 and Table 8.

TABLE 7
Table of third metasurface lens parameters

| | R(mm) | A₁ | A₂ | A₃ | A₄ |
|---|---|---|---|---|---|
| Metasurface 201 | 1 | −587.421 | −24.934 | 2.249 | 4.125 |
| | R(mm) | A₅ | A₆ | A₇ | A₈ |
| Metasurface 201 | 1 | −1.734 | 0.364 | −0.046 | 3.425E−03 |
| | R(mm) | A₉ | A₁₀ | A₁₁ | A₁₂ |
| Metasurface 201 | 1 | −9.735E−05 | −5.512E−06 | −5.596E−07 | −1.433E−08 |
| | R(mm) | A₁ | A₂ | A₃ | A₄ |
| Metasurface 202 | 1 | 367.686 | 256.001 | 10.735 | −73.669 |
| | R(mm) | A₅ | A₆ | A₇ | A₈ |
| Metasurface 202 | 1 | 390.125 | −1072.541 | 1610.984 | −888.697 |
| | R(mm) | A₉ | A₁₀ | A₁₁ | A₁₂ |
| Metasurface 202 | 1 | −1056.971 | 2245.537 | −1557.446 | 402.733 |

TABLE 8
Optical structure parameters of third optical system

| | Radius of Curvature | Thickness or | Material or | Aperture |
|---|---|---|---|---|
| Component | (mm) | Spacing (mm) | Model No. | (mm) |
| Laser emitter 1 | — | — | — | — |
| | — | 1 | | — |
| Double-sided | Infinity (metasurface) | 0.5 | Silicon | 5.4 |
| metasurface lens 2 | Infinity (metasurface) | 5 | | 5.4 |
| Columnar lens | −2.953 | 1 | IRG207 | 2 |
| | −3.572 | 5 | | 2.6 |
| Image plane 3 | Infinity | — | — | 2.6 |

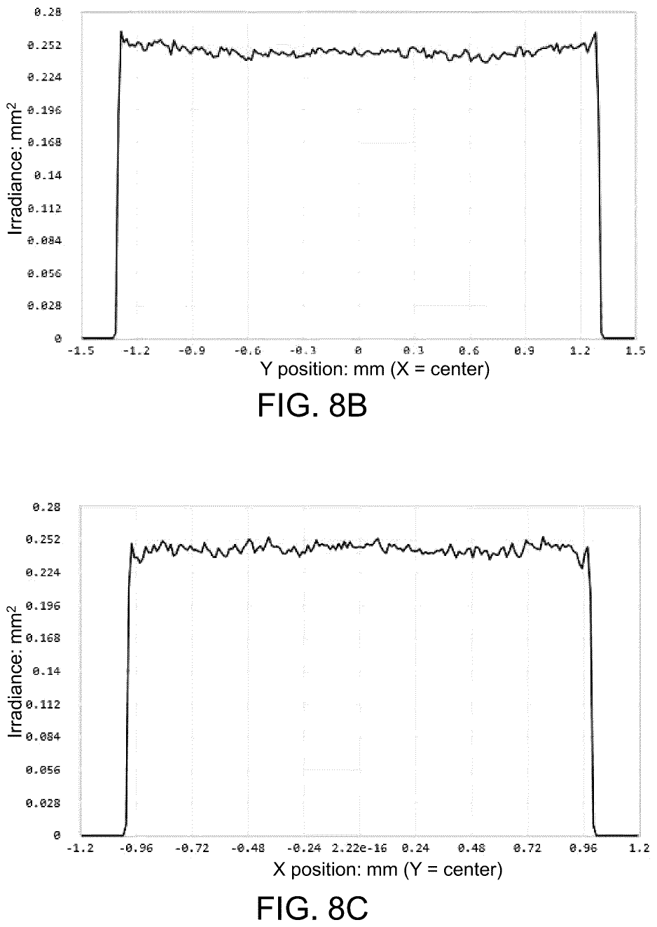

Calculation is performed using the uniformity definition formula, and the shaping effect of the optical system provided in this embodiment for a laser with a wavelength of 10.6 micrometers is shown in Table 9. The angle between the outgoing light beam and the optical axis is less than 2.6× 10⁻³ rad, and parallelism of the light beam is good. The target spot is elliptical, a major axis of the elliptical spot of 1.3 mm, and a minor axis is 1 mm. The irradiance distribution of the spot on the image plane is shown in FIG. 8(a), and the irradiance distribution of the spot in the X and Y directions on the image plane is shown in FIG. 8(b) and FIG. 8(c).

TABLE 9
Uniformity parameters of third optical system

| | Columnar Lens to Image Plane Distance/mm | | | |
|---|---|---|---|---|
| | 2.5 | 5 | 7.5 | 10 |
| Uniformity in Major | 0.9714 | 0.9562 | 0.9546 | 0.9573 |
| Axis Direction | | | | |
| Uniformity in Minor | 0.9595 | 0.95 | 0.9456 | 0.9344 |
| Axis Direction | | | | |

In the above embodiments, the combination of double-sided metasurface lens and refractive lens is analyzed, proving that this optical system structure is suitable for shaping different target spots. Meanwhile, when changing the distance between the columnar lens and the image plane, the calculated uniformity does not change significantly.

The embodiment of the invention provides a metasurface lens that shapes a Gaussian light beam into parallel uniform light, and only a metasurface lens is used. By virtue of the fine control capability of the metasurface lens on the incident light, the shaping of laser is achieved, ensuring that the outgoing light emits in parallel with high uniformity. This design only adopts a metasurface lens, so the optical system structure is simple, the application range is wide, and it is suitable for laser shaping of various laser devices.

### Embodiment Two

The invention further provides a design method of the metasurface lens for shaping Gaussian light into parallel uniform light as described in any one of Embodiment One, and the following steps are included.

In S1, according to the working wavelength of the laser emitter and the beam waist diameter of the emitted laser, as well as the shape and size of the target spot, the phase distribution of the metasurface lens is calculated.

In S2, according to the current phase distribution of the metasurface lens, the parameters of the outgoing light beam formed after the laser is shaped by the metasurface lens is calculated, where the parameters of the outgoing light beam include: the shape, size, and uniformity of the spot of the outgoing light beam on the image plane.

In S3, if the shape, size, and uniformity of the spot of the outgoing light beam on the image plane satisfy the design needs, S5 is executed; otherwise, according to the working wavelength of the laser emitter and the beam waist diameter of the emitted laser, the phase distribution parameters of the metasurface lens are optimized and updated through the damped least squares method and the self-defined optimization algorithm.

In S4, the updated phase distribution is substituted into and S2 to S3 are repeatedly executed until the shape, size, and uniformity of the spot of the outgoing light beam on the image plane obtained in S2 satisfy the design needs.

In S5, according to the current phase distribution of the metasurface lens, the size and arrangement of the plurality of columnar microstructure units in the metasurface lens are designed.

In S6, according to the data in S5, the metasurface lens is fabricated to construct the laser shaping optical system.

Optionally, S5 includes the following.

Coefficient fitting is performed on the target phase distribution of the metasurface lens, so that discrete points of the fitted phase distribution correspond one-to-one with the columnar microstructure units of the metasurface lens.

A correspondence relationship between the size and phase distribution of the columnar microstructure units in the metasurface lens and transmittance is simulating and obtained.

According to the phase distribution after the coefficient fitting, the correspondence relationship is queried to obtain the size and arrangement of the plurality of columnar microstructure units.

Optionally, the simulating and obtaining the correspondence relationship of the size and phase distribution of the columnar microstructure units in the metasurface lens includes the following.

According to the finite-difference time-domain algorithm and the rigorous coupled-wave analysis method, size parameters of the columnar microstructure units of the metasurface lens are simulated to determine the correspondence relationship between the height, period, and diameter and the phase distribution of the columnar microstructure units and the transmittance.

Herein, in the calculation of S1, a personalized optimization function set in simulation software and a built-in optimization algorithm are used, and the built-in optimization algorithm of the simulation software is the damped least squares method.

The personalized optimization function set in the simulation software divides the incident light and outgoing light into n concentric circles according to different field of view, where the concentric circles formed by the incident light ray and the concentric circles formed by the outgoing light ray under the same field of view correspond one-to-one, calculates the actual radial coordinates of the corresponding outgoing light ray on the image plane according to the irradiance distribution of the incident light beam and the irradiance distribution of the outgoing light ray, and simultaneously discretizes and analyzes the outgoing light so as to make it emit parallel to the optical axis. The phase distribution of the metasurface microstructure is then calculated according to the above relationship.

According to the design method for the metasurface lens for shaping the Gaussian light beam into parallel uniform light provided by this embodiment, the metasurface lens for shaping the Gaussian light beam into parallel uniform light designed and manufactured exhibits the corresponding beneficial effects as described in the above embodiments.

A person having ordinary skill in the art should be able to easily understand that the above description is only preferred embodiments of the disclosure and is not intended to limit the disclosure. Any modifications, equivalent replacements, and modifications made without departing from the spirit and principles of the disclosure should fall within the protection scope of the disclosure.

1. A metasurface lens for shaping Gaussian light into parallel uniform light, comprising: a dielectric substrate layer and a metasurface microstructure,
wherein the metasurface microstructure comprises a first metasurface and a second metasurface distributed on both sides of the dielectric substrate layer, each of which comprises a plurality of columnar microstructure units, the plurality of columnar microstructure units are arranged into a tetragonal lattice periodic array or hexagonal lattice periodic array, each of the columnar microstructure units has a same height, and a distribution of the plurality of columnar microstructure units matches an incident light beam, so that the incident light beam, after being shaped, forms an outgoing light beam that is parallel to an optical axis and uniformly distributed within a target range.

2. The metasurface lens according to claim 1, wherein heights of the columnar microstructure units are on a wavelength order of the incident light beam, diameters of the columnar microstructure units are on a sub-wavelength order, a phase is distributed according to a periodic array, and a phase distribution φ1 of the first metasurface and a phase distribution φ2 of the second metasurface respectively satisfy the following expressions:
$${φ}_{1} = [ {{A}_{1} ( \frac{ρ}{R} )}^{2} + {{A}_{2} ( \frac{ρ}{R} )}^{4} + … + {{A}_{n - 1} ( \frac{ρ}{R} )}^{2 n - 2} + {{A}_{n} ( \frac{ρ}{R} )}^{2 n} ] ( 2 π rad ) , and \\ {φ}_{2} = [ {{B}_{1} ( \frac{ρ}{R} )}^{2} + {{B}_{2} ( \frac{ρ}{R} )}^{4} + … + {{B}_{n - 1} ( \frac{ρ}{R} )}^{2 n - 2} + {{B}_{n} ( \frac{ρ}{R} )}^{2 n} ] ( 2 π rad ) ,$$
where ρ represents radial coordinates of the metasurface lens, R is a normalized radius, n is a maximum number of terms in the phase distribution φ1 and the phase distribution φ2, Aᵢ and Bᵢ are polynomial coefficients, and i=1, 2, 3, . . . n.

3. The metasurface lens according to claim 1, wherein characterized in that-both front and back surfaces of the metasurface lens are coated with anti-reflection coating layers.

4. The metasurface lens according to claim 1, wherein characterized in that a material refractive index of the columnar microstructure units is greater than or equal to a material refractive index of the dielectric substrate layer.

5. A design method of the metasurface lens according to claim 1, comprising:
step S1, according to a working wavelength and a beam waist diameter of the incident light beam and a shape and size of a target spot, calculating a phase distribution of the metasurface lens;
step S2, according to a current phase distribution of the metasurface lens, calculating parameters of the outgoing light beam formed after the incident light beam is shaped by the metasurface lens, wherein the parameters of the outgoing light beam comprise: a shape, size, and uniformity of a spot of the outgoing light beam on an image plane;
step S3, if the shape, the size, and the uniformity of the spot of the outgoing light beam on the image plane satisfy a design needs, executing step S5; otherwise, according to the working wavelength and the beam waist diameter of the incident light beam, optimizing and updating phase distribution parameters of the metasurface lens through a damped least squares method and a self-defined optimization algorithm;
step S4, substituting the updated phase distribution and repeatedly executing the step S2 to the step S3 until the shape, the size and the uniformity of the spot of the outgoing light beam on the image plane obtained in the step S2 satisfy the design needs;
step S5, according to the current phase distribution of the metasurface lens, designing a size and an arrangement of the plurality of columnar microstructure units in the metasurface lens; and
step S6, according to data obtained in the step S5, fabricating the metasurface lens to construct a laser shaping optical system.

6. The design method according to claim 5, wherein the step S5 comprises:
performing coefficient fitting on a target phase distribution of the metasurface lens, so that discrete points of a fitted phase distribution correspond one-to-one with the columnar microstructure units of the metasurface lens;
simulating and obtaining a correspondence relationship between the size and the phase distribution of the columnar microstructure units in the metasurface lens and transmittance; and
according to the phase distribution after the coefficient fitting, querying the correspondence relationship to obtain the size and the arrangement of the plurality of columnar microstructure units.

7. The design method according to claim 6, wherein the simulating and obtaining the correspondence relationship between the size and the phase distribution of the columnar microstructure units in the metasurface lens and the transmittance comprises:
according to a finite-difference time-domain algorithm and a rigorous coupled-wave analysis method, simulating size parameters of the columnar microstructure units of the metasurface lens to determine the correspondence relationship between a height, a period, a diameter, and the phase distribution of the columnar microstructure units and the transmittance.

8. The design method according to claim 5, wherein a customized optimization algorithm in the step S3 comprises:
dividing the incident light beam and the outgoing light beam into a plurality of concentric circles according to different field of view, where the concentric circles formed by the incident light beam and the concentric circles formed by the outgoing light beam under a same field of view correspond one-to-one, calculating actual radial coordinates of the corresponding outgoing light beam on the image plane according to an irradiance distribution of the incident light beam and an irradiance distribution of the outgoing light beam, and simultaneously discretizing and analyzing the outgoing light beam so as to make it emit parallel to the optical axis.
